(19) United States
(12) Patent Application Publication
(10) Pub. No.: US 2003/0206105 A1
(43) Pub. Date: Nov. 6, 2003

(54) Optical security system

(76) Inventors: Igor A. Grebenshchikov, Stockton, CA (US); Alexander Povarov, San Jose, CA (US); David Margulis, Campbell, CA (US)

Correspondence Address: Boris Kesil, MultiMetrixs, LLC, 1059 Di Giulio Avenue, Santa Clara, CA, 95050, US

(21) Appl. No.: 10/138,065

(22) Filed: May 3, 2002

(51) Int. Cl. G08B 13/18

(52) U.S. Cl. 340/556

(57) ABSTRACT

According to one embodiment of the invention, the optical security system consists of a first laser beam generation and feedback signal receiving station on one end of the security zone and a second laser beam receiving and feedback signal transmitting station on the other end of the security zone. The first station consists of a laser source that generates a modulated low-divergence laser beam and a first optical signal receiver. The second station consists of a second optical signal receiver that receives the aforementioned modulated low-divergence laser beam emitted from the laser source and a feedback optical signal transmitter which is connected to the aforementioned second optical signal receiver via a signal processing unit which codes the received signal and forms it into a feedback signal to be sent to the first optical signal receiver of the first station from the transmitter of the second station. In the system of the second embodiment the feedback signals are in the form of IR, MW, or RF signals. The intruder is detected by comparing changes in the codes of direct and return signals.

### FIELD OF INVENTION

The present invention relates to a security system, in particular to an optical security system based on the principle of detecting intentional or unintentional intruders, including human beings, animals or moving objects in general, into unauthorized or forbidden areas, such as a military weapon test ground, a hazardous area, e.g., a contaminated zone, or the like.

### BACKGROUND OF THE INVENTION

It is often required to prevent penetration of unauthorized individuals to such areas as shooting ranges, state borders, hazardous zones, test grounds, or the like.

The problems become more aggravated when it is necessary to provide protection of large areas, i.e., areas with large perimeters. The larger is the area, the greater is the perimeter, the more expensive is the system, and the more difficult is to provide reliable protection. An increase in the secured areas is associated not only with an increase in expenses, but also with technical problems, since surveying of large areas is limited by technical capacities of existing light sources, transmitters, receivers, and data processing devices. Another problem is a significant time required for assembling and disassembling of existing security systems, e.g., for temporary use. Such a problem may occur, when it is necessary to prevent temporary, e.g., seasonal, penetration of people into an avalanche zone, or a fire-hazardous zone, or the like.

There exist a great variety of security systems of various types operating on different principles. Roughly such systems can be divided into optical beam interruption systems, microwave beam interruption systems, acoustic, e.g., ultrasonic beam interruption systems, visual control systems, infrared-sensor type systems, etc. All these systems have their advantages and drawbacks and can be used most efficiently under specific conditions. For example, security systems intended for protection against penetration into a building through windows or doors will obviously be unsuitable for surveying an open area with a large perimeter.

SP&T Company, Canada commercially produces Series 14000 bistatic microwave long-range intrusion detection systems (trademark Senstar-Stellar) which provide invisible volumetric perimeter protection for a distance up to 1500 m. offering a current operation less than 100 mA per system at 12 VDC. The site-specific installation and/or operational detection coverage is determined with a built-in audio sidetone that is proportional to radar target size and velocity. The complete system consists of a transmitter, receiver, and mounting hardware. Each unit requires 12 VDC power. For multiple operations in areas highly-congested with radio-frequency irradiation, the system requires the use of an E-Plane vertical antenna polarization and 3,5-degree beam pattern (see SP&T News, April 2000, Reader Service Card #344, Canada).

A main disadvantage of the system described above is its sensitivity to radio-frequency interferences, which may generate false alarm. Another drawback is large dimensions of the transmitter and receiver, which makes it difficult to provide concealed installation of the system.

An example of another commercially produced security system is a microwave protection system known as Intelli-WAVE manufactured by Magal Security Systems Ltd., Yahud, Israel.

The Intelli-WAVE 4100 Bi-Static Microwave Sensor consists of a transmitter and a receiver located up to 183 m (600 ft.) apart. The transmitter incorporates a dielectric resonant oscillator (DRO) frequency source for increased stability over temperature ranges. The 10 GHz signal is amplitude-modulated at one of six field-selectable frequencies. An invisible pattern of microwave energy is established between the transmitter and the receiver.

The receiver incorporates signal processing with wider dynamic range, enhanced target signature analysis and minimum susceptibility to interference. Changes in signal amplitude analyzed at the receiver are directly related to the intruder's size, density and speed. The receiver uses a preamplifier to ensure that there is an adequate signal sent o the processor in situations such as sally ports with transmission through fences where signal loss can be significant.

The Intelli-WAVE pattern width increases with range. Pattern height varies in conjunction with pattern width. The polarization plane of the antenna can be selected to enhance signal isolation when units are operated in close proximity.

The rear entry of the enclosure enables the installer to easily make adjustments to the unit. The unit incorporates a built-in LED bar graph for alignment and an audio jack for troubleshooting nuisance alarms. The design allows plug-in modular replacement of all parts without changing the alignment.

In spite of the all advantages and technical sophistication of the Intelli-WAVE system, it is still has large dimensions which make it difficult to provide concealed installation. Another disadvantage is a relatively short radius of action (183 m). The system is expensive and requires maintenance.

U.S. Pat. No. 3,683,352 issued in 1972 to H. West, et al. discloses an alarm system for sensing intruders. The system utilizes a laser that generates a light beam, which extends through a plurality of isolated detectors and ends at a control station. A detector includes two optical-electronic transducers, one of which is used for detecting an intruder by the temporary blocking of the beam. There is no electrical wiring connecting the detector stations, and a signal denoting an intruder is sent over the laser beam into the form of an amplitude or polarization modulation at a characteristic frequency. This signal is received at the control station, its frequency of modulation is determined, and an alarm is activated.

A disadvantage of such a system is that, in principle, it can be easily deactivated by an unauthorized person after determining characteristics of the aforementioned signal and by suppressing the system signal with a counter signal of the same type.

U.S. Pat. No. 6,259,365 issued in 2001 to J. Hagar, et al. discloses a laser security fence apparatus for providing a warning signal in response to an intrusion by an intruder of a restricted area. The apparatus includes a laser generator for generating a laser beam and a first mirror aligned with the laser beam for reflecting the beam. A second mirror is aligned with the first mirror for reflecting the beam reflected by the first mirror, and a collector is aligned with the second mirror for collecting the beam reflected by the second mirror. A microprocessor is associated with the collector and the generator for sensing interruption of the beam by the intruder when the beam is not received by the collector. An alarm is connected to the microprocessor for actuation by the microprocessor when the microprocessor senses that the beam is interrupted so that the alarm provides the warning signal.

In contrast to the system of U.S. Pat. No. 3,683,352, the security system of U.S. Pat. No. 6, 259,365 has a feedback from a receiver to the transmitter via a group of beam-redirecting mirrors. However, the use of the aforementioned mirrors limits the use of the system only to indoor applications and makes the system more difficult for installation and adjustment.

### OBJECT AND SUMMARY OF THE INVENTION

It is an object of the invention to provide an optical or a combined optical-electromagnetic security system which is simple in construction, reliable in operation, composed of components having miniature dimensions, easy to install and dismantle, contains self-contained module-type components, can be easily transferred to another location and quickly remotely activated or deactivated. It is another object to provide an optical or combined optical-electromagnetic security system that can be quickly and frequently coded and decoded. Another object is to provide an optical or combined optical-electromagnetic security system, which overlaps long-haul distances (up to a few miles) with minimal beam divergence at the receiving end. Still another object is to provide a method for surveying a selected area against penetration of intruders by utilizing two mutually interconnected transmission-receiving units for transmitting an optical signal from the first unit to the second and an optical or electromagnetic signal back from the second unit to the first one for comparing modulation and coding characteristics of the return signal with those of the original one.

According to one embodiment of the invention, the optical security system consists of a first laser beam generation and feedback signal receiving station on one end of the security zone and a second laser beam receiving and feedback signal transmitting station on the other end of the security zone. The first station consists of a laser source that generates a modulated low-divergence laser beam and a first optical signal receiver. The second station consists of a second optical signal receiver that receives the aforementioned modulated low-divergence laser beam emitted from the laser source and a feedback optical signal transmitter which is connected to the aforementioned second optical signal receiver via a signal processing unit which codes the received signal and forms it into a feedback signal to be sent to the first optical signal receiver of the first station from the transmitter of the second station.

The system of the second embodiment is in general similar to the first one and differs from it by sending the feedback signals in the form of infrared (IR), radio frequency (RF), or microwave (MW) signals transmitted from the second station to an appropriate IR, RF, or MW receiver at the first station operating on the same frequency and with the same modulation of the signal.

In both embodiments, the first station also contains electronics for processing the feedback signals and for detecting an intruder by comparing the received feedback signal with the signal originally sent to the second station.

### BRIEF DESCRIPTION OF THE DRAWINGS

FIG. 1 is a schematic view of an optical security system made according to one embodiment of the invention.

FIG. 2 is a more detailed view of an optical signal collimator.

FIG. 3 is a view of a system made in accordance with another embodiment of the invention, which is based on optical detection and on electromagnetic feedback.

### DETAILED DESCRIPION OF THE INVENTION

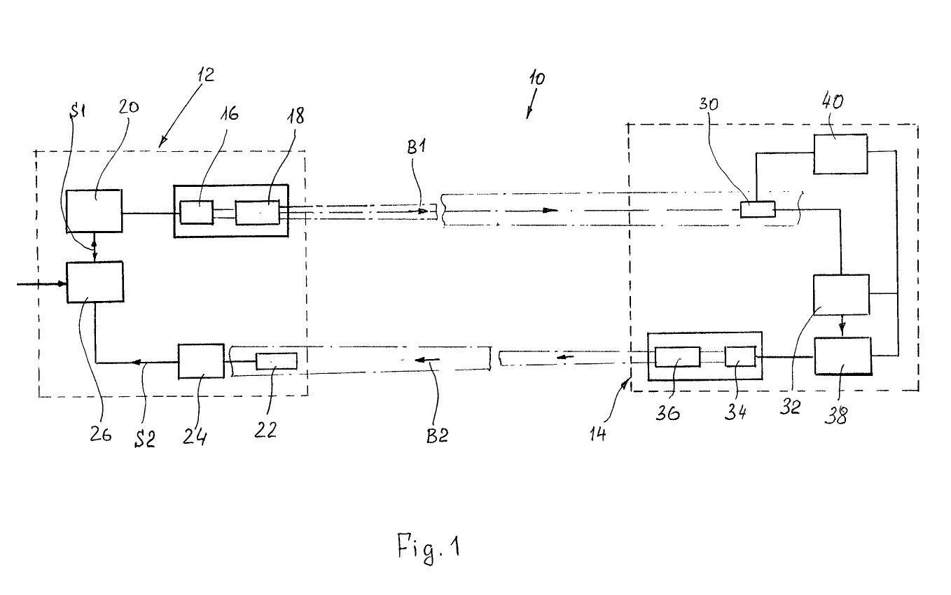

An optical security system made according to one embodiment of the invention is shown in FIG. 1. This optical security system, which in general is designated by reference numeral 10, consists of a first transmitting-receiving unit 12 located in point of the zone to be secured and a second transmitting-receiving unit 14 located remotely from the first unit 12 at a distance that spans the entire area to be surveyed with the security system 10.

The transmitting-receiving unit 12 consists of the following components: a signal source, in this case a laser diode 16 with an optical beam collimator 18 located in front of the laser diode emitter (not shown); a laser driver 20 for ignition of the laser diode 16 and for maintaining the laser diode 16 in operation mode; a signal receiving sensor 22 with a signal amplifier 24 for receiving and amplifying external optical signals; a central processing unit 26 which is connected to both the laser driver 20 and the signal amplifier 24 of the sensor 22. The central processing unit 26 is also connected to an alarm 25 that may comprise a sound alarm, a light signal generator, or a display.

The code information is inputted into the central processing unit 26 and can be easily changed via a new input. On the basis of the code information, the central processing unit 26 codes the signal to be generated at the laser diode 16 by specifying, e.g., duration of pulses and relative duration of pulses (or time intervals between the pulses), with variation of the pulses and relative duration of pulses from one pulse train to the other. The signal codes can be easily changed via the central processing unit 26. Furthermore, the central processing unit 26 contains a signal comparator and processing unit 28, which compares the code of the aforementioned external signals received by the signal sensor 22 with the code of optical signals sent by the laser diode 16.

The second transmitting-receiving unit 14 consists of the following components: a signal-receiving sensor 30 with a signal amplifier 32 for receiving and amplifying the coded signals sent from the laser diode 16 in the form of a collimated laser beam B1; a second laser diode 34 with a laser beam collimator 36 located in front of the emitter (not shown) of the laser diode 34 for sending optical signals to the sensor 22 of the first transmitting-receiving unit 12. It is understood that driver 38 modulates the signal obtained from the amplifier 32 with the code specified by the central processing unit 26. Reference numeral 40 designates a source of electrical power that supplies energy to the sensor 30, amplifier 32, and driver 38.

The laser diodes 16 and 34 can be represented, e.g., by a lasers ML1016R-01, ML 60114R of Mitsubishi Electric Co. working on 660 nm or 785 nm wavelength with power in a CW mode equal to 30 mWt, and pulse mode up to 50 mWt duty cycle 25.

It is understood that the maximum distance between the laser diode 16 and the signal-receiving sensor 30, and hence between the laser diode 34 and the sensor 22, is determined by the sensitivity threshold of the respective sensors 16 and 22. For practical use, this sensitivity threshold should be no less than 1 mkW/mm². Since the power of the aforementioned laser sources is limited, in order to increase the distance between the light source and the sensor, it is necessary to minimize the cross-section of the beam on the receiving side. It is also well known that the size of the beam cross section is determined by the beam divergence. The divergence of a beam generated by a laser is minimal in a single-mode diffraction-limited light beam. In other words, for surveying large areas with significant distances between the first receiving-transmitting unit 12 and the second receiving-transmitting unit 14, the security system 10 of the invention is based on generation of single-mode laser beam B1.

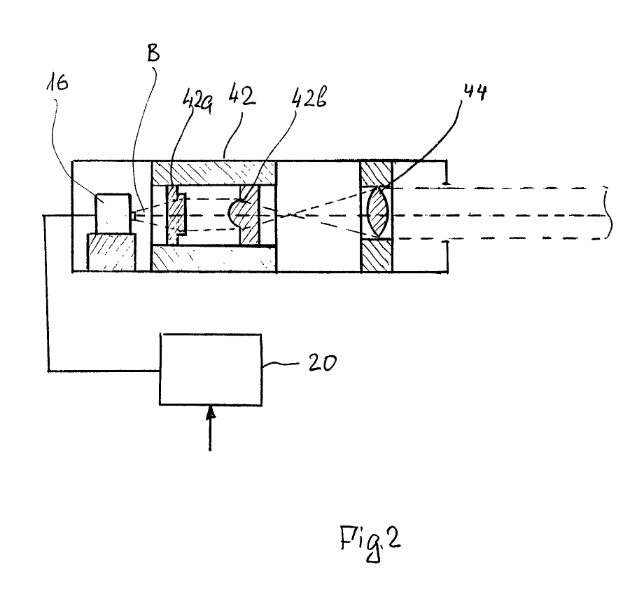

Although this problem has been solved for gas and solid-state lasers, it is not so trivial or easily solvable for laser diodes. This is because the emitter of a laser diode has an asymmetric form (e.g., a rectangular form of about 1 μm×4 μm) with different beam divergences along the short and long axes of the beam cross section. This difference may be as high as tenfold. Therefore the formation of a laser beam of a symmetric cross section or at least providing equal beam divergences on both axes present a technical problem. The above function is accomplished by means of the collimators 18 and 36 (FIG. 1). Each of these collimators comprises at least a bi-lens optical system composed of aspheric or anamorphous cylindrical lenses which level the divergences along the “fast” and “slow” mutually orthogonal axes, where the “fast” axis is the one with the maximal divergence and the “slow” axis is the one with the minimal divergence. A schematic view of a laser-beam collimator 18 or 36 is shown in FIG. 2. The collimator (let us assume that this is the collimator 18 and that the collimator 36 is the same) is normally combined into an integral unit with a laser diode (in this case the laser diode 16) and comprises an aspheric or an anamorphic objective 42. As shown in FIG. 2, such an objective consists of a lens 42a, a lens 42b, and a telescopic lens 44. The lens 42a may correspond to correction of divergence on the “fast” axis, and the lens 42b may correspond to correction of divergence on the “slow” axis of the beam.

For a laser beam with a Gaussian light-intensity distribution and with an ideal diffraction-limited divergence, the diameter of the beam at a distance of about 1 mile will be about 25 cm (the diameter is the one where intensity of light on the periphery of the circle having this diameter corresponds to half intensity of the beam at the central point of the circle). The input aperture of any sensor suitable for practical use will not normally exceed 3 to 5 mm. It is understood that the signal is picked up by the area of the sensor defined by the diameter of the aperture. In other words, the real optical power received by the sensor 22 or 30 is equal to the power of the light source multiplied by a ratio of the light-receiving area of the sensor to the cross-section of the beam B1 at the point of incidence on the sensor.

It is also understood that the sensor 30 or 22 should not respond to false signals such as incidence of direct solar rays or natural light flashes onto the sensors By using matched pair signals that modulated the transmitter and only recognized by signal processing unit of receiver. Variations in the level of such false signals could be at least 10⁴ 410⁵ higher than the variation of signals changed by an intruder. As has been mentioned above, for practical purposes the sensitivity threshold of the sensors 22 and 30 should be no less than 1 mkW. This threshold determines the power of light source required for stable and reliable operation of the system 10 as a whole.

The following are examples of the sensors that may satisfy the above conditions: S6846 or S4282-51 from Hamamatsu, Japan.

The system shown in FIG. 1 operates as follows:

The system 10 shown in FIG. 1 can be instantly activated or deactivated at any moment. Let us assume that the beam is to be sent from the transmitting-receiving unit 12 to the transmitting-receiving unit 14. For activation of the system 10, the laser driver 20, which is controlled from the central processing unit 26, ignites the laser diode 16 for maintaining it in operation mode. A laser beam B emitted from the laser diode 16 is collimated by the collimator 18 shown in detail in FIG. 2. More specifically, the anisotropy in the divergence of the beam B is corrected by passing the beam B in sequence through the lenses 42a and 42b. After being corrected, the beam B is collimated by a collimating lens 44 in the form of corrected and collimated beam B2. This beam has a cross section substantially circular. If necessary, any other shape can be imparted to the cross section of beam BI by utilizing an appropriate optics, instead of the lenses 42a and 42b. For example, aspheric lenses (not shown) can be used for this purpose. What is important to note in this regard, is that beam B1 will be cleared from any other components of divergence except for an inevitable diffraction divergence component. Therefore, the beam will have the minimal possible cross-sectional area and thus the maximum possible specific light intensity for the given light power of the laser diode 16.

As has been mentioned earlier, the driver 20 is controlled by the central processing unit 28, which modulates the current of the laser diode 16, and hence, the amplitude of optical signals. The optical signals that form beam B1 can be sent with predetermined duration and intervals. Variation or combination of these parameters in time makes it possible to code the signals.

On its way from the collimator 18 on the side of the transmitting-receiving unit 12 to the sensor 30 on the side of the transmitting-receiving unit 14 the beam B1 is slightly diverged due to diffraction divergence. The cross-sectional area of beam B1 is increased by several hundred times and may have a diameter of about 20-30 cm at a distance of about 1 mile. This means that the intensity of light sensed by the sensor 30 will also be diminished by several hundred times. However, this intensity will be significantly higher than the threshold of the sensor 30.

The optical signals received by the sensor 30 in the form of a signal train are converted into electrical signals, e.g., voltage signals, which are amplified by the amplifier 32, wherefrom the signals are sent via the controller (not shown) of the amplifier to the laser diode 34. The driver 38 activates the laser diode 34 with a mode of modulation that corresponds to the signals received by the sensor 30 and amplified by the amplifier 32. The laser diode 34 sends optical signals in the form of beam B2 to the sensor 22 on the side of transmitting-receiving unit 12. Similar to beam B1, beam B2 is also corrected and collimated by the collimator 36, and is received on the sensor 22 with the cross section enlarged due to diffraction divergence. The sensitivity of the sensor 22 is substantially lower than dynamical range of the intensity of the signals received by this sensor.

After being received by the sensor 22, the optical signals converted by the sensor 22 into electrical signals S2, e.g., voltage signals, are amplified by the amplifier 24 and are sent to the comparator 28 of the central processing unit 26. The comparator 28 also contains signals S1 (that form beam B1) from the central processing unit 26. The comparator 28 compares signals S1 and S2, taking into account the delay caused by passing of beam B1 from the laser diode 16 to the sensor 30 and by passing of beam B2 from the laser diode 34 to the sensor 22.

In the case the comparator 26 does not find deviations between the signals S1 and S2 (taking into the account the aforementioned delay), the system 10 continues to operate without alarm. If, however, signals S1 and S2 are different in any aspect, e.g., in time, sequence, amplitude, or any other elements of the code, the central processing unit 26 will activate the alarm 25.

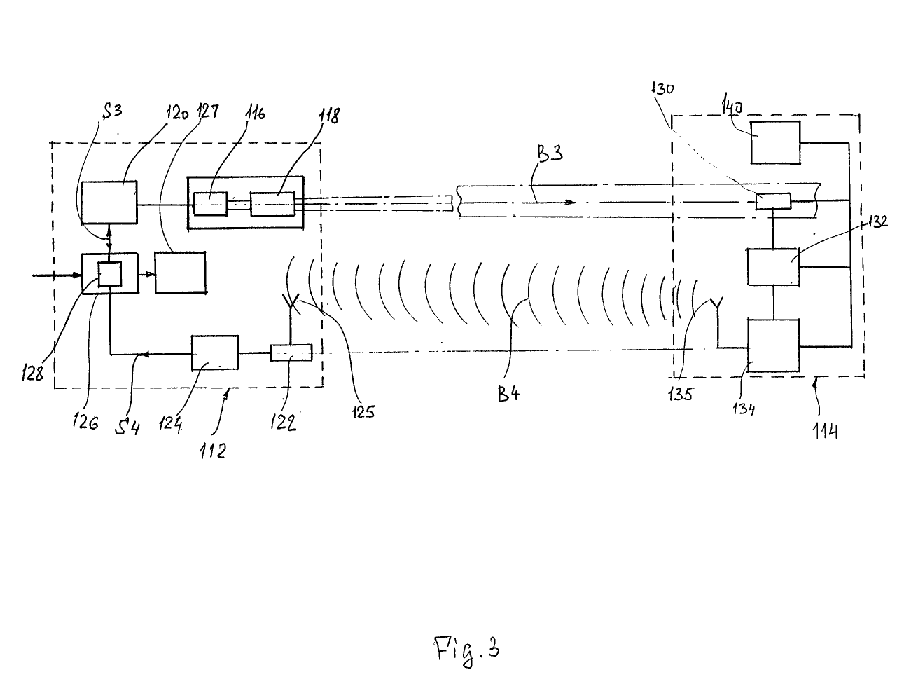

FIG. 3 illustrates another embodiment of the security system of the invention, which combines optical signals with electromagnetic feedback. This system, which in general is designated by reference numeral 110, has some elements and components similar to those contained in the previously described system 10. Therefore, the parts and components of the system 110 similar to those of the system 10 will be designated by the same reference numerals with an addition of 100.

A combined optical-electromagnetic security system made according to the embodiment of FIG. 3 is in general designated by reference numeral 110. The system 110 consists of a first transmitting-receiving unit 112 located in a point of the zone to be secured and a second transmitting-receiving unit 114 located remotely from the first unit 112 at a distance that spans the entire area to be surveyed with the security system 110.

The transmitting-receiving unit 112 consists of the following components: a signal source, in this case a laser diode 116 with an optical beam collimator 118 located in front of the laser diode emitter (not shown); a laser driver 120 for ignition of the laser diode 116 and for maintaining the laser diode 116 in operation mode; an electromagnetic signal receiver 122 with an electromagnetic signal amplifier 124 and an antenna 125 for receiving external electromagnetic signals; a central processing unit 126 which is connected to both the laser driver 120 and the signal amplifier 124 of the electromagnetic signal receiver 122. The central processing unit 126 is also connected to an alarm 127 that may comprise a sound alarm, a light signal generator, or a display.

The central processing unit 126 codes the signal to be generated at the laser diode 116 by specifying, e.g., duration of pulses and relative duration of pulses (or time intervals between the pulses), with variation of the pulses and relative duration of pulses from one pulse train to the other. The signal codes can be easily changed via the central processing unit 126. Furthermore, the central processing unit 126 contains a signal comparator 128, which compares the code of the aforementioned external signals received by the electromagnetic signal receiver 122 with the code of optical signals sent by the laser diode 116.

The laser diode 116 can be represented, e.g., by a laser ML 60114R or ML1016R of Mitsubishi Electric Corp. working on 785 nm and 660 nm wavelength with power in a CW mode equal to 30 mWt and pulse mode up to 50 mWt with duty cycle more then 25.

The second transmitting-receiving unit 114 consists of the following components: a signal-receiving sensor 130 with a signal amplifier 132 for receiving and amplifying the coded signals sent from the laser diode 116 in the form of a collimated laser beam B3; an electromagnetic-wave transmitter 134 (for transmitting RF, MW, or IR signals) with an appropriate antenna 135.

Reference numeral 140 designates a source of electrical power that supplies energy to the sensor 130, amplifier 132, and transmitter 134.

It is understood that the maximum distance between the laser diode 116 and the signal-receiving sensor 130, and hence between the laser diode 134 and the sensor 122, is determined by the sensitivity threshold of the respective sensors 116 and 122. For practical use, this sensitivity threshold should be no less than 1 mkW. Since the power of the aforementioned laser sources is limited, in order to increase the distance between the light source and the sensor, it is necessary to minimize the cross-section of the beam on the receiving side. It is also well known that the size of the beam cross section is determined by the beam divergence. The divergence of a beam generated by a laser is minimal in a single-mode diffraction-limited light beam. In other words, for surveying large areas with significant distances between the first receiving-transmitting unit 112 and the second receiving-transmitting unit 114, the security system 110 of the invention is based on generation of single-mode laser beam B3.

The functions of the laser 116, collimator 118, and the sensor 130 used in the system of the embodiment of FIG. 3 and their technical requirements are the same as those for the system of FIG. 1. Therefore their description is omitted.

In the case the transmitter 140 is an IR transmitter, it is recommended to use a Ming TX-99 V3.0 300 MHz AM, RF Transmitter module produced by Reynolds Electronics, Colorado, USA. The receiver 122 can be represented by Ming RE-99 V3.0A RF receiver produced by the same company for work in cooperation with the transmitter Ming TX-99 V3.0.

The system shown in FIG. 3 operates as follows:

The system 110 shown in FIG. 3 can be instantly activated or deactivated at any moment. Let us assume that the beam is to be sent from the transmitting-receiving unit 112 to the transmitting-receiving unit 114. For activation of the system 110, the laser driver 120, which is controlled from the central processing unit 126, ignites the laser diode 116 for maintaining it in operation mode. A laser beam emitted from the laser diode 116 is collimated by the collimator 118, which is similar to the one shown in detail in FIG. 2. More specifically, the anisotropy in the divergence of the beam is corrected by passing the beam in sequence through the lenses of the collimator. After being corrected, the beam emitted from the laser diode 120 is collimated by the collimator 118 in the form of corrected and collimated beam B3. This beam has a cross section substantially circular. The beam B3 will have the minimal possible cross-sectional area and thus the maximum possible specific light intensity for the given light power of the laser diode 116.

As has been mentioned earlier, the driver 120 is controlled by the central processing unit 128, which modulates the current of the laser diode 116, and hence, the amplitude of optical signals. The optical signals that form beam B3 can be sent with predetermined duration and intervals. Variation or combination of these parameters in time makes it possible to code the signals.

On its way from the collimator 118 on the side of the transmitting-receiving unit 112 to the sensor 130 on the side of the transmitting-receiving unit 114 the beam B3 is slightly diverged due to diffraction divergence. The cross-sectional area of beam B3 is increased by several hundred times and may have a diameter of about 20-30 cm at a distance of about 1 mile. This means that the intensity of light sensed by the sensor 30 will also be diminished by several hundred times. However, this intensity will be still hundreds times higher than the threshold of the sensor 130.

The optical signals received by the sensor 130 in the form of a signal train are converted into electrical signals, e.g., voltage signals, which are amplified by the amplifier 132, wherefrom the signals are sent via a microcontroller (not shown) of the amplifier to the electromagnetic-wave transmitter 134 (IR, RF, or MW transmitter). Via the antenna 135, the transmitter 134 sends RF, IR, or MW signals B4 to the antenna 125 of the respective RF, IR, or MW receiver 122 on the side of transmitting-receiving unit 112.

After being received by the receiver 122, the electromagnetic signals B4 are converted into a signal envelope S4 by a signal converter (not shown) and sent to the comparator 128 of the central processing unit 126. The comparator 128 also contains signals S3 (that form beam B3) from the central processing unit 126. The comparator 128 compares signals S3 and S4, taking into account the delay caused by passing of beam B3 from the laser diode 116 to the sensor 130 and by passing signals B4 from the transmitter 134 to the receiver 122.

In the case, the comparator 126 does not find deviations between the signals S3 and B4 (taking into the account the aforementioned delay), the system 110 continues to operate without alarm. If, however, signals S3 and S4 are different in any aspect, e.g., in time, sequence, amplitude, or any other elements of the code, the central processing unit 126 will activate the alarm 125.

Thus it has been shown that the invention provides an optical or combined optical-electromagnetic security system which is simple in construction, reliable in operation, composed of components having miniature dimensions, easy to install and dismantle, contains self-contained module-type components, can be easily transferred to another location and quickly remotely activated or deactivated. The system can be quickly and frequently coded and decoded and can overlap long-haul distances (up to E1 few miles) with minimal beam divergence at the receiving end. The invention also provides a method for surveying a selected area against penetration of intruders by utilizing two mutually interconnected transmission-receiving units for transmitting an optical signal from the first unit to the second and an optical or electromagnetic signal back from the second unit to the first one for comparing modulation and coding characteristics of the final signal with those of the original one.

Although the invention has been shown in the form of specific embodiments, it is understood that these embodiments were given only as examples and that any changes and modifications are possible, provided they do not depart from the scope of the appended claims. For example, though the system was described with reference to surveying open spaces where the optical beams are not interrupted by various natural or artificial obstacles, the areas blocked by the obstacles can be protected by using reflective mirrors going around the obstacles. In the simplified version the receiver and transmitter of the second transmission-receiving unit may be replaced by at least one mirror. However, such a system is applicable only for surveying small areas or indoor spaces. The lasers, transmitters, receivers, sensors, etc. may have characteristics different from those given as examples.

What we claim is:

1. An optical security system for protection of a selected area that overlaps a distance from penetration of an intruder, comprising:
a first transmission-receiving unit located in a first point of said selected area; and
a second transmission-receiving unit located in said selected area and remote therefrom at said distance;
said first transmission-receiving unit comprising: a light source for generation of a direct light beam propagated in the direction of said second transmission-receiving unit; a collimator unit for collimating said direct light beam; beam modulating unit for modulating said direct light beam in a selected code; a return-beam receiving unit; a control unit for controlling operation of said light source, said control unit being connected to said light source and to said a return-signal receiving unit, said control unit having a comparison unit; and an alarm unit connected to said comparison unit;
said second transmission-receiving unit comprising: a direct-beam receiving unit for receiving said direct light beam; and a return signal generation unit connected to said direct-beam receiving unit for generation of a return signal to be sent to said return-signal receiving unit in said selected code; said comparison unit comparing said selected code of said direct light beam with said selected code of said return signal for initiation of said alarm unit when said selected code of said return signal does not coincide with said selected code of said direct light beam.

2. The optical security system of claim 1, wherein said light source for generation of a direction light beam and said return signal generation unit are laser diodes with optical collimators, said return signal comprising a return light beam, said direct beam receiving unit and said return beam receiving unit being optical sensors.

3. The optical security system of claim 2, wherein said laser diodes are single-mode laser diodes, said direct light beam and said return light beam each having a fast axis with the maximal beam divergence and a slow axis with the minimal beam divergence.

4. The optical security system of claim 3, wherein each of said collimators comprises an objective composed of at least a first optical lens for correcting said maximum beam divergence, a second optical lens for correcting said minimal beam divergence, and a telescopic lens for directing a corrected collimated beam towards a respective sensor.

5. The optical security system of claim 4, wherein said objective is selected from the group consisting of an aspheric objective and an anamorphic objective.

6. The optical security system of claim 2, wherein said direct light beam and said return light beam are diffractive-limited beams.

7. The optical security system of claim 5, wherein said direct light beam and said return light beam are diffractive-limited beams.

8. The optical security system of claim 2, wherein said direct light beam and said return light beam each comprises optical signals modulated in said selected code and sent in signal trains.

9. The optical security system of claim 8, wherein said optical signals are modulated with regard to parameters selected from the group consisting of an amplitude, duration of signals, duration of interval between said signals, and time between said signal trains.

10. The optical security system of claim 5, wherein said direct light beam and said return light beam each comprises optical signals modulated in said selected code and sent in signal trains.

11. The optical security system of claim 10, wherein said optical signals are modulated with regard to parameters selected from the group consisting of an amplitude, duration of signals, duration of interval between said signals, and time between said signal trains.

12. The optical security system of claim 7, wherein said direct light beam and said return light beam each comprises optical signals modulated in said selected code and sent in signal trains.

13. The optical security system of claim 12, wherein said optical signals are modulated with regard to parameters selected from the group consisting of an amplitude, duration of signals, duration of interval between said signals, and time between said signal trains.

14. The optical security system of claim 1, wherein said return signal generation unit comprises electromagnetic-signal generation unit.

15. The optical security system of claim 14, wherein said electromagnetic-signal generation unit is selected from the group consisting of an IR signal transmitter, RF signal transmitter, and MW signal transmitter.

16. The optical security system of claim 15, wherein said light source for generation of a direction light beam is a laser diode with an optical collimator, said return signal comprising a signal selected from an IR signal, RF signal, and MW signal, said return beam receiving unit being an electromagnetic-wave receiver selected from the group consisting of IR signal receiver, RF signal receiver, and MW signal receiver.

17. The optical security system of claim 14, wherein said laser diode is a single-mode laser diode, said direct light beam having a fast axis with the maximal beam divergence and a slow axis with the minimal beam divergence.

18. The optical security system of claim 17, wherein said collimator comprises an objective composed of at least a first optical lens for correcting said maximum beam divergence, a second optical lens for correcting said minimal beam divergence, and a telescopic lens for directing a corrected collimated beam towards a respective sensor.

19. The optical security system of claim 18, wherein said objective is selected from the group consisting of an aspheric objective and an anamorphic objective.

20. The optical security system of claim 14, wherein said direct light beam is a diffractive-limited beam.

21. The optical security system of claim 16, wherein said direct light beam is a diffractive-limited beam.

22. The optical security system of claim 14, wherein said direct light beam comprises optical signals modulated in said selected code and sent in signal trains.

23. The optical security system of claim 22, wherein said optical signals are modulated with regard to parameters selected from the group consisting of an amplitude, duration of signals, duration of interval between said signals, and time between said signal trains.

24. The optical security system of claim 16, wherein said direct light beam comprises optical signals modulated in said selected code and sent in signal trains.

25. The optical security system of claim 24, wherein said optical signals are modulated with regard to parameters selected from the group consisting of an amplitude, duration of signals, duration of interval between said signals, and time between said signal trains.

26. The optical security system of claim 20, wherein said direct light beam comprises optical signals modulated in said selected code and sent in signal trains.

27. The optical security system of claim 26, wherein said optical signals are modulated with regard to parameters selected from the group consisting of an amplitude, duration of signals, duration of interval between said signals, and time between said signal trains.

28. A method for protection of a selected area that overlaps a distance from penetration of an intruder, comprising:
providing a first transmission-receiving unit located in a first point of said selected area;
providing a second transmission-receiving unit located in said selected area and remote therefrom at said distance;
transmitting optical signals from said first transmission-receiving unit to said second transmission-receiving unit;
modulating said optical signals in a selected code thus forming modulated optical signals;
receiving said modulated optical signals at said second transmission-receiving unit;
converting said modulated optical signal in said second transmission-receiving unit into return signals modulated in said selected code;
sending return signals to said first transmission-receiving unit;
comparing said selected code of said optical signals with said selected code of said return signals received by said first transmission-receiving unit; and
generating an alarm signal if said selected code of said optical signals does not coincide with said selected code of said return signals received by said first transmission-receiving unit.

29. The method of claim 28, comprising the step of diffractionally limiting divergence of said optical signals by collimating said optical signals with an optical collimator that corrects said optical beam along an axis of the maximum divergence and along an axis of the minimal divergence.

30. The method of claim 29, wherein said return signals are return optical signals, said method further comprising the step of diffractionally limiting divergence of said return optical signals by collimating said return optical signals with an optical collimator that corrects said optical beam along an axis of the maximum divergence and along an axis of the minimal divergence.

31. The method of claim 29, wherein said return signals are selected from IR signals, RF signals, and MW signals.
